(19) United States
(12) Patent Application Publication
(10) Pub. No.: US 2017/0021204 A1
(43) Pub. Date: Jan. 26, 2017

(54) OXYGEN RESPIRATOR FOR EMERGENCY EVACUATIONS

(71) Applicant: CIJ, Daejeon (KR)

(72) Inventor: Jong Tae BAEK, Daejeon (KR)

(73) Assignee: CIJ, Daejeon (KR)

(21) Appl. No.: 15/100,173

(22) PCT Filed: Nov. 29, 2013
(86) PCT No.: PCT/KR2013/011017

§ 371 Date: May 27, 2016

(30) Foreign Application Priority Data
Nov. 29, 2013 (KR) 10-2013-0147295

(51) Int. Cl. A62B 18/02; A62B 23/02; A62B 9/02; A62B 18/08; A62B 7/02; A62B 7/12; A62B 9/00; A62B 18/10; A62B 25/00

(52) U.S. Cl. CPC A62B 18/025; A62B 18/10; A62B 23/02; A62B 9/02; A62B 25/00; A62B 7/02; A62B 7/12; A62B 9/006; A62B 18/084

(57) ABSTRACT

An oxygen respirator is provided for emergency evacuations, which is simple to carry. The oxygen respirator increases the amount of air which a user can breathe by reusing the expirations of the user, such that the survival rate of the user is increased.

### TECHNICAL FIELD

The present invention relates to an oxygen respirator for emergency evacuations, which is simple to carry so as to be used for preventing respirator distress or suffocation under a situation such as fire or discharge of toxic gas.

### BACKGROUND ART

Danger of a lot of accidents including collapse, fire, and the like lurks in various industrial sites. In particular, since ventilation is not easy in an enclosed work space, most workers die due to the suffocation when the accidents including the collapse, the fire, and the like occur.

An escape time in a suffocation accident site is just about average 5 minutes, but most workers cannot endure for 3 to 5 minutes just before rescue and are suffocated to death. Accordingly, in a fire site or a toxic gas leakage site, only when rapid rescue and smooth supply of oxygen should be achieved, damage of suffocation death can be minimized. In particular, it has been known that most life accidents of workers who work in enclosed industrial sites in which there is a risk of the fire or toxic gas leakage occur due to the suffocation death caused due to respiratory obstruction as a main cause. Therefore, it is very important to make the workers rapidly breathe air which is not contaminated under such a disaster situation.

Conventionally, a gas mask as protective equipment for making the workers breathe clean air is generally used in a disaster site and since the gas mask cannot completely filter poisonous substances, the gas mask is problematic in terms of safety, and the like. In particular, in the case of a fire site, as oxygen is combusted, an oxygen amount in the air significantly decreases and when the oxygen amount in the air decreases to 18% or less, stable respiration is impossible with the gas mask, and as a result, there is a problem in providing the safety.

In the case of a portable oxygen respirator in the related art, users breathe oxygen in an oxygen tank separately provided and a small amount of oxygen is conventionally injected into the oxygen tank. The portable respirator in the related art is disclosed in Korean Patent Unexamined Publication No. 2012-0124′719 (“Oxygen Respirator for Emergency evacuations”, Nov. 14, 2012).

Sine it is complicated to use the portable oxygen respirator in the related art, it is difficult to rapidly supply the portable oxygen respirator and rapidly use the portable oxygen respirator under an emergency situation. Further, in the fire site or an accident site where the toxic gas leaks, it is difficult to secure a clear view, and as a result, it is very difficult to find a position where the oxygen respirator is furnished. In addition, when a long rescue time is required due to a delayed rescue operation, clean oxygen which can be supplied is insufficient, and as a result, the users inhale contaminated air or toxic gas in the accident site. Therefore, the users may be suffocated to death.

### DISCLOSURE

### Technical Problem

An object of the present is to provide an oxygen respirator for emergency evacuations which is easily detachable/attachable from/to a holder which can be provided in a body of a user in a form of conveniently folding a mask module and reducing the volume of the mask module so that the user immediately uses the oxygen respirator at a location where the user is positioned without going to find a location where a portable oxygen respirator is furnished under an emergency situation.

Another object of the present invention is to provide an oxygen respirator for emergency evacuations which prevents an exhaled breath discharged when a user respires from being inhaled again, prevents contaminated air in an accident site from being input into a respirator, and is rapidly and easily usable even under an emergency situation.

Yet another object of the present invention is to provide an oxygen respirator for emergency evacuations which stores oxygen in an oxygen tank and stores an exhaled breath of a user, reuses the stored exhaled breath by removing carbon dioxide and humidity from the stored exhaled breath, and easily recharges oxygen to make the user consistently and stably breathe oxygen for a sufficient time until the user is rescued.

Still yet another object of the present invention is to provide an oxygen respirator for emergency evacuations which transmits information such as inter-user distance information under a disaster situation, position information and a status (motion) of a user to a control center to rapidly rescue the user and in particular, more easily achieves a rescue operation when the user is locked in an enclosed space or cannot move.

### Technical Solution

An exemplary embodiment of the present invention provides an oxygen respirator for emergency evacuations in which respective components are coupled to or separated from each other and a communication means enabling mutual communication between users or communication with a control center is provided, including: a face mask in which the center of the face mask is formed to be convex and the face mask is thus in close contact with the face so as to cover a mouth and a nose of the user and the oxygen is contained in the face mask and a check valve is formed on one side of the face mask; a filtering unit formed to include a pouch connection portion formed on one side thereof, a filter unit of which one side is in communication with the pouch connection portion and the other side is in communication with the face mask, and a filtering means formed in the filter unit; a pouch check valve formed in the filtering unit; a pouch storing an exhaled breath of the user and connected to the pouch connection portion at one side so as to reuse the stored exhaled breath by removing carbon dioxide and oxygen through the filter unit; and an oxygen supply hose of which one side is in communication with the filtering unit and the other side is connected to an oxygen tank to supply oxygen, wherein a mask module is formed to include the face mask, the filtering unit, the pouch, and the oxygen supply hose and the mask module and the oxygen tank are used while being provided in a supporter or a backpack

The oxygen respirator for emergency evacuations first may store the exhaled breath in a pouch through the pouch check valve and discharge the remaining exhaled breath to the outside through the mask check valve when the user respires.

The filtering means may include a filter formed in a sheet shape in which carbon and zeolite are stacked; and a filter protection member provided in an anteroposterior direction of the filter to protect and support the filter and formed in a mesh structure.

The oxygen respirator may further include a band bracket between the filter unit and the pouch.

The oxygen tank may be constituted by one selected from an oxygen compression container having a high pressure of 1 to 500 atmospheric pressure and having a small capacity less than 300 cc, an oxygen generation container using an oxygen generation agent, and an oxygen storage container in which gaseous oxygen is absorbed and using, an oxygen storage releasing the absorbed oxygen, and a combination of a plurality of containers and further include a static pressure type depressurizer.

The face mask may be formed in a folding type or a bellows type or a combination of the folding type and the bellows type.

The filtering unit may be coupled with the face mask so that the filter unit is projected to the front of a convex portion of the face mask.

The filtering unit may be coupled with the face mask so that the filter unit is projected to the bottom of the convex portion of the face mask.

The oxygen supply hose as a hose of a material which is resistant to pressure and is flexible may be connected with the oxygen tank by one touch fitting.

The plurality of oxygen tanks may be connected in series or in parallel, and as result, when one oxygen tank is consumed, another oxygen tank may be able to be used.

The supporter may be constituted by any one of a vest type, a shoulder strap type, a belt type (buckle type), and a handbag type or a combination of a plurality of types.

The mask module and the communication means may be provided in a pocket Or a backpack of the supporter and the pocket may be formed to be detached from or coupled to the supporter.

The communication means may give a warning by one selected from sound, letters, and flickering of a combination of a plurality of forms by sensing a distance between users and a motion of the user.

The communication means may use paring of Bluetooth communication and ZigBee communication for sensing the distance between the users and the motion of the user.

The communication means may recognize a location and a distance of the user by using active badge using infrared or ultrasonic waves or a radar scheme using a propagation signal to perform bidirectional communication with the control center.

The communication means may transmit a dangerous situation to the control center when there is no motion by using a motion sensor, a vibration sensor, or a gyro sensor.

The oxygen respirator may further include a lighting device or a luminous body.

Another exemplary embodiment of the present invention provides a method for using an oxygen respirator for emergency evacuations, in which a detour check valve is formed on the face mask, an exhaled breath is stored in a pouch through the detour check valve and a pouch connection portion and thereafter, the stored exhaled breath is breathed by removing carbon dioxide and moisture through a filter or the filter includes each of an exhaled breath filter and an inhaled breath filter and when the carbon dioxide is removed by using the exhaled breath filter and the moisture is removed by the inhaled breath filter the exhaled breath is stored in the pouch through the exhaled breath filter and the stored air is breathed through the inhaled breath filter or when a common filter is used for the exhaled breath and the inhaled breath, the air is breathed by simultaneously removing the carbon dioxide and the moisture through the same filter during respiration or the exhaled breath is stored in the pouch through the pouch check valve and air acquired by removing the carbon dioxide and the moisture included in the stored exhaled breath through the filter is breathed.

### Advantageous Effects

According to an exemplary embodiment of the present invention, an oxygen respirator for emergency evacuations is constituted by small equipment to be formed to be easily detachable/attachable from/to a holder which can be provided in a body of a user to immediately supply fresh oxygen at a location where the user is positioned under an emergency situation, thereby reducing an inhalation amount of toxic gas of the user.

Further, the oxygen respirator for emergency evacuations forms and stores a space storing an exhaled breath of the user and reuses the stored exhaled breath again and uses the exhaled breath for respiration to allow the user to consistently and stably breathe oxygen for a sufficient time until the user is rescued.

In addition, the oxygen respirator for emergency evacuations can perform bidirectional communication with a control center by using a communication means provided in a face mask to rapidly rescue the user and in particular, allow the user to be rapidly and easily rescued when the user is locked in art enclosed space or cannot move.

### DESCRIPTION OF MAIN REFERENCE NUMERALS OF DRAWINGS

10: Face mask

10a: Bellows

11: Band

12: Mask check valve

13: Communication means

20: Filtering unit

20a: Filter unit

20b: Pouch connection portion

21: Supply pipe

22: Filter protection member

23: Filter

24: Filtering means

27: Pouch check valve

30: Pouch

40: Oxygen tank

41: Flow control valve

42: One touch fitting

43: Oxygen supply hose

50: Vest

51: Module pocket

54: Oxygen tank pocket

### DESCRIPTION OF DRAWINGS

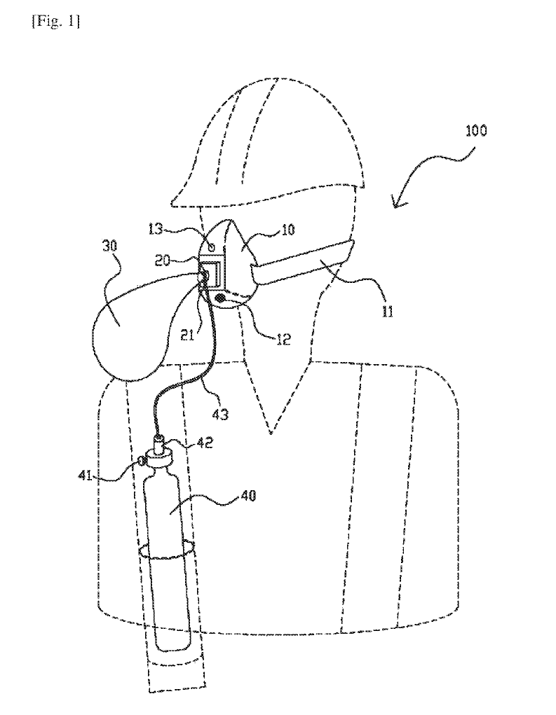

FIG. 1 is a diagram illustrating a status of a user who wears an oxygen respirator for emergency evacuations according to the present invention.

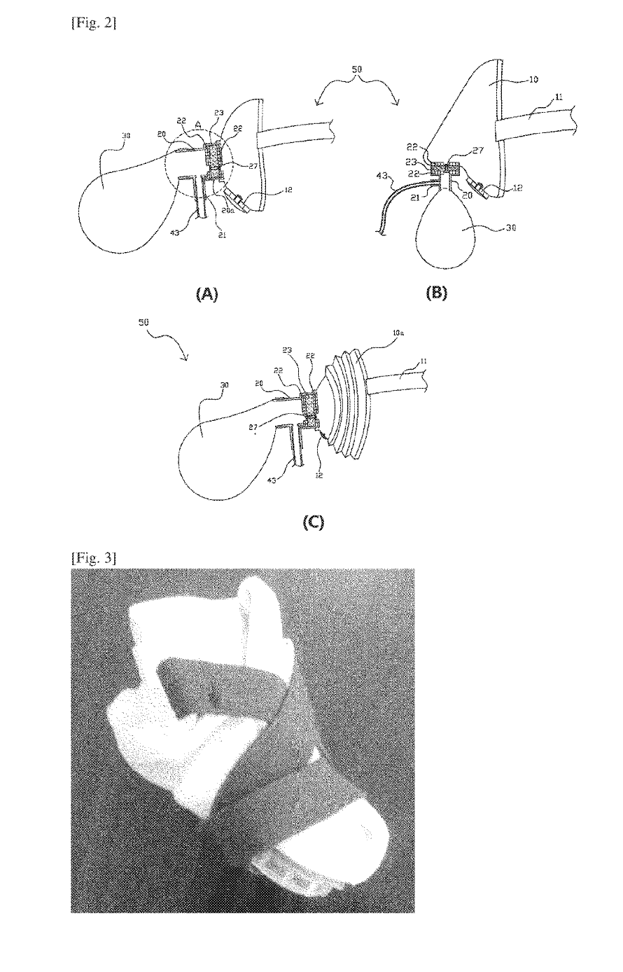

FIG. 2 illustrates various exemplary embodiments of the oxygen respirator for emergency evacuations according to the present invention.

FIG. 3 is a diagram illustrating a folding status of a mask module according to the present invention.

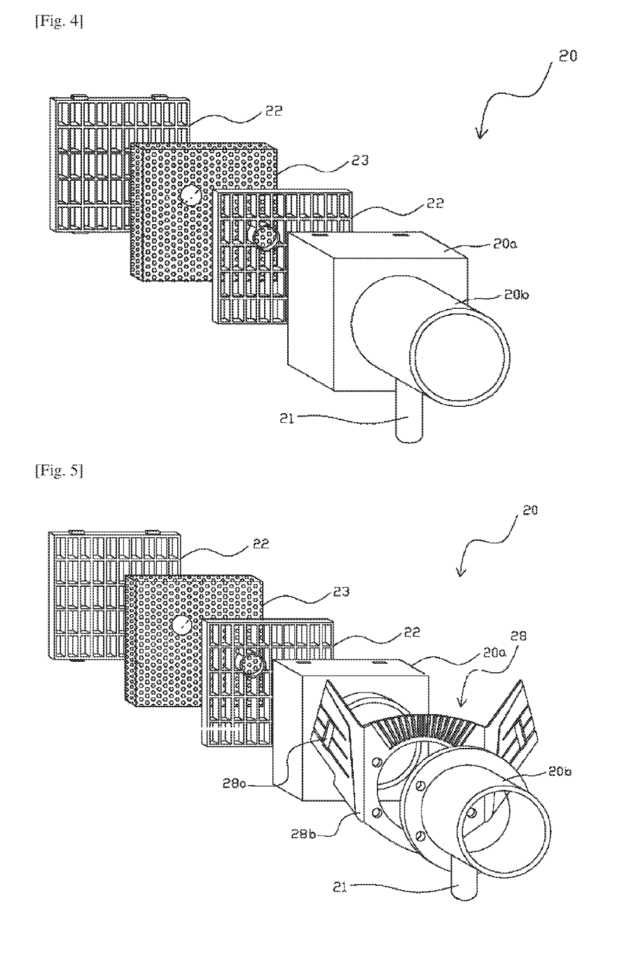

FIG. 4 is an exploded perspective view of a filtering unit according to a first exemplary embodiment of the present invention.

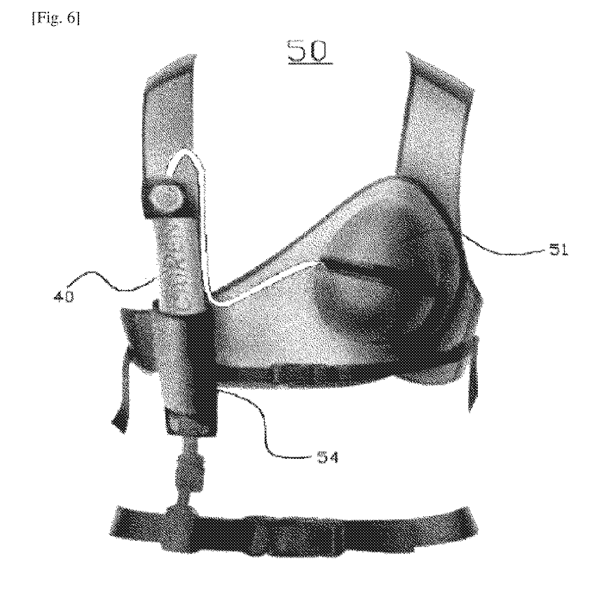

FIG. 5 is an exploded perspective view of a filtering unit according to a second exemplary embodiment of the present invention.

FIG. 6 illustrates another exemplary embodiment of a support according to the present invention.

### BEST MODE

Hereinafter, the technical spirit of the present invention will be described in more detail with reference to the accompanying drawings.

Since the accompanying drawings are just one example illustrated for describing the technical spirit of the present invention in more detail, the technical spirit of the present invention is not limited to forms of the accompanying drawings.

FIG. 1 is a diagram illustrating a status of a user who wears an oxygen respirator for emergency evacuations according to the present invention.

As illustrated in FIG. 1, an oxygen respirator 100 for emergency evacuations according to the present invention is generally configured to include a mask module 50 and an oxygen tank 40 and the mask module 50 is configured to include a face mask 10 a filtering unit 20, a pouch 30, and an oxygen supply hose 43. The mask module 50 and the oxygen tank 40 have a small size to be provided in a holder 50 and conveniently carried, and as a result, the oxygen respirator 100 for emergency evacuations according to the present invention, which a user exposed to an emergency situation crimes is immediately used on the spot to easily supply fresh oxygen, thereby reducing an amount of toxic gas which the user inhales.

The mask module 50 is in close contact with a face of the user under an emergency situation to receive oxygen from the oxygen tank 40.

The center of the thee mask 10 is formed to be convex and the face mask 10 is thus in close contact with the face so as to cover a mouth and a nose of the user and the oxygen is contained in the face mask 10 and a mask check valve 12 is formed on one side of the face mask 10. The face mask 10 may be easily worn under the emergency situation and a band 10 is joined to the face mask 10 to be fixed to a head so as to freely use both hands.

The face mask 10 is made of a material such as silicon or rubber so as to be easily folded with flexibility, and as a result, the face mask 10 is formed to have a small volume and high portability.

he filtering unit 20 is formed to include a pouch connection portion 20b formed on one side thereof, a filter unit 20a of which one side is in communication with the pouch connection portion 20b and the other side is in communication with the face mask 10, and a filtering means 24 formed in the filter unit 20a.

The pouch 30 stores an exhaled breath of user and is connected to the pouch connection portion 20b so as to reuse the stored exhaled breath by removing carbon dioxide and oxygen through the filter unit 20a. The pouch 30 is made of a material which is light and durable, such as thin vinyl, silicon, or urethane, and as a result, the pouch 30 may be easily unfolded or folded and there is a small danger of damage in use of the pouch 30.

he oxygen supply hose 43 is in communication with the filtering unit 20 through a supply pipe 21 formed on one side of the filtering unit 20 and the other side of the oxygen supply hose 43 is connected with the oxygen tank 40 to supply the oxygen into the face mask 10.

The face mask 10 is used in fully close contact with the face of the user so as to prevent external contaminated an born being input during respiration. In this case, when the user utters the exhaled breath, an internal pressure of the face mask 10 increases and the face mask 10 may not be in fully close contact with the face of the user, and as a result, it is impossible to stably use the face mask 10. Further, there is a problem in that: a ratio of the carbon dioxide included in the exhaled breath, which occupies the inside of the face mask 10 increases. In order to solve the problem, the mask check valve 12 is provided and when the internal pressure of the face mask 10 increases up to a predetermined pressure or more, internal air of the face mask 10 is released to the outside of the face mask 10. That is, when the user utters the exhaled breath, the mask check valve 12 is opened and at the moment when the exhaled breath is changed to an inhaled breath, the mask check valve 12 is enclosed again when the pressure decreases to discharge the exhaled breath to the outside and prevent external air from being input into the face mask 10. As a result, a constant pressure is maintained in the face mask 10 and the user continuously inhales the fresh air.

Meanwhile, when the user evacuates late or the user is locked in the enclosed space under a disaster situation, even though the user uses the oxygen respirator, when a rescue operation is delayed, all of oxygen in the oxygen tank 40 is exhausted, and as a result, there is a danger that the user may be suffocated to death. Accordingly, the oxygen respirator 100 for emergency evacuations of the present invention includes the pouch 30 to filter and reuse the exhaled breath of the user, and as a result, air which the user may breathe increases and thus, a survival time also increases. Therefore, a survival rate oldie user may increase.

The pouch check valve 27 is provided for reusing the exhaled breath. As described above, the face mask 10 includes the mask check valve 12 to discharge the internal air to the outside in order to control the internal pressure and the rate of the carbon dioxide. In this case, the pouch check valve 27 is configured so that the internal air of the face mask 10 is first stored in the pouch 30. Pressures required for opening the pouch cheek valve 27 and the mask check Valve 12 are made to be different from each other to first store the exhaled breath in the pouch 30. That is, when the internal pressure of the face mask 10 increases to a predetermined pressure by making the opening pressure of the pouch check valve 27 be higher than the opening pressure of the mask check valve 12, the pouch check valve 27 is first opened to store the exhaled breath in the pouch 30 and when the internal pressure of the pouch 30 is higher than the internal pressure of the pouch 30 by the stored exhaled breath, the check valve is enclosed to prevent the stored exhaled breath from being discharged. When a predetermined amount of exhaled breath is stored in the pouch 30, the remaining exhaled breath increases the internal pressure of the face mask 10 to be discharged to the outside through the mask check valve 12. In the case where the internal pressure of the face mask 10 is higher than the internal pressure of the pouch 30 when the user takes the inhaled breath during the respiration, the exhaled breath stored in the pouch 30 is opened to enable respiration and the carbon dioxide and the humidity are removed from the inhaled, breath through the filter unit 20a to be reused. (A method for removing the carbon dioxide and the humidity in the filter unit 20a will be hereafter described in detail.) As a result, the user may consistently and stably breathe the oxygen for a sufficient time until the user is rescued to increase the survival rate of the user.

The face mask 10 may be formed to further include a detour check valve (non illustrated) formed on the face mask 10. The detour check valve (not illustrated) is connected with the pouch connection portion 20b through a hollow connection member such as a hose, or the like, and as a result, the exhaled breath of the user is detoured to be stored in the pouch 30.

Opening degrees of the mask check valve 12 and the pouch check valve 27 may be controlled by the intensity of elastic force, that is, a material, a thickness, or a spring strength of a diaphragm.

Meanwhile, the oxygen tank 40 is constituted by one selected among an oxygen compression container, an oxygen generation container, or an oxygen storage container or a combination of a plurality of containers. In this case, the oxygen tank 40 is formed to further include a depressurizer (not illustrated) and as the depressurizer (not illustrated), a static pressure type depressurizer is preferably used in order to constantly supply the oxygen. A flow control valve 41 is formed on one side of the oxygen tank 40 and stored compressed oxygen passes through the filtering unit 20 to be used for the respiration of the user.

When the internal pressure of the oxygen tank 40 becomes a high pressure of a predetermined atmospheric pressure or more, the oxygen tank 40 or the depressurizer (not illustrated) may be formed to further include a safety device that automatically discharges high-pressure gas in order to resolve an explosion danger.

The oxygen generation container is manufactured by a small container which is compressed by a high pressure of 1 to 500 atmospheric pressure and has a capacity of 300 CC or less to prevent interruption of the operation of the user when the user performs an operation while carrying the oxygen respirator 100 for emergency evacuations according to the present invention.

An oxygen generating agent such as potassium peroxide (KO₂) or manganese oxide (MnO₂) is charged in the oxygen generation container in a granular form and reacts with the carbon dioxide to generate the oxygen. Alternatively, powder acquired by mixing potassium peroxide (KO₂), manganese oxide (MnO₂), and silicon oxide (SiO₂) are charged in the oxygen generation container in the granular form and reacts with water to generate the oxygen.

Gaseous oxygen is absorbed in the oxygen storage container and the oxygen storage container discharges the absorbed oxygen by using an oxygen storage such as ceria (CeO₂) or ceria-zirconia (ZrO₂).

Approximately 21% of oxygen is included in the an and 5% is consumed during one respiration. Therefore, when the exhaled breath of the user is reused by using the pouch 30, the rate of the carbon dioxide increases by the amount of the consumed oxygen as the respiration is repeated. Accordingly, consistent supply of the oxygen is required, and as a result, when the worker is equipped with the oxygen tank 40 as the safety device, the user may be equipped with a plurality if oxygen tanks 40 against a case in which a location of a working space is distant from a location of an escapable exit. The plurality of oxygen tanks 40 are connected in series or in parallel, and as a result, when one is consumed, another oxygen tank 40 may be used. Therefore, when an escape distance is long, the oxygen may be supplied to the user for a long time.

In general, the user is equipped with an oxygen tank 40 compressed with 200 atmospheric pressure and having a capacity of 200 cc and when the exhaled breath is reused through the pouch 30, the user may inhale the air for a maximum of approximately 8 minutes. Therefore, n oxygen tanks 40 are provided to extend a respiration time as many as the provided oxygen tanks 40.

Meanwhile, the oxygen supply hose 43 as a hose of a material which is resistant to pressure and is flexible is connected with the oxygen tank 40 by one touch fitting 42.

FIG. 2 illustrates various exemplary embodiments of the oxygen respirator 100 for emergency evacuations according to the present invention.

As illustrated in FIG. 2A, the filtering unit 20 is coupled with the face mask 10 so that the filter unit 20a is projected to the front of a convex portion of the face mask 10.

As illustrated in FIG. 2B, the filtering unit 20 is coupled with the face mask 10 so that the filter unit 20a is projected to the bottom of the convex portion of the face mask 10, When the filtering unit 20 is projected to the front, since the pouch 30 is expanded by the exhaled breath to cover a front view, the pouch 30 is more preferably configured to face the bottom.

As illustrated in FIG. 3C, the face mask 10 may be formed in a bellows type 10a, and as a result, the volume decreases, thereby easily carrying the face mask 10. The face mask 10 may be configured in a folding type as described above and the face mask 10 may be configured even by a combination of the folding, type and the bellows type 10a in order to further increase the portability.

FIG. 3 is a diagram illustrating a folding status of a mask module 50 according to the present invention.

As illustrated in FIG. 3, the mask module 50 of the present invention is easily folded and the mask module 50 may be thus miniaturized through folding, and as a result, carrying the mask module 50 is convenient and when packaging is separated, the mask module 50 is easily stretched to be easily used under the emergency situation.

FIG. 4 is an exploded perspective view of a filtering unit 20 according to a first exemplary embodiment of the present invention.

As described above, the filtering unit 20 is formed to include the pouch connection portion 20b, the filter unit 20a, and the filtering means 24.

The pouch connection portion 20b and the filter unit 20a are formed to be separated from each other or formed to be integrally injected.

The filter unit 20a includes the filtering means 24 therein and the filtering means 24 is configured to include a filter 23 removing the carbon dioxide and the humidity and a filter protection member 22.

The filter 23 is formed in a sheet shape in which carbon and zeolite are stacked and the filter protection member 22 is provided in an anteroposterior direction of the filter 23 to protect and support the filter 23 and is formed in a mesh structure to easily circulate the air when the user respires.

A mesh shape of the filter protection member 22 is not limited to a shape illustrated in FIG. 4 and the air may be easily circulated and a design of the filter protection member 22 is changed even to any structure that may support the filter 23.

FIG. 5 is an exploded perspective view of a filtering unit 20 according to a second exemplary embodiment of the present invention.

The oxygen respirator 100 for emergency evacuations according to the present invention is configured to further include a band bracket 28 between the filter unit 20a and the pouch 30.

The band bracket 28 is used for fixing the mask module 50 to the face of the user and the mask module 50 and the band 10 are coupled with each other by inserting the band 10 into an insertion groove 28a formed in the band bracket 28. The mask module 50 coupled with the band 10 is easily fixed to the head of the User to prevent the mask module 50 from sliding down Of being crooked under an emergency evacuations situation, thereby effectively cutting off the external contaminated air and facilitating the evacuation.

The band bracket 28, the pouch connection portion 20b, and the filtering unit 20 are separately manufactured to be assembled or may be integrally manufactured. A bent portion 28b of the band bracket 28 is manufactured in a flexible hinge shape and when the user wears the mask module 50, the bent portion 28b may serve as a supporter that erects the mask and the bent portion 28b may reduce the volume of the mask module 50 by folding the mask module while keeping the mask module 50.

Cross-sections of the pouch connection portion 20b and the filter unit 20a may be variously modified to have various shapes including a circular shape, a polygonal shape, and the like.

FIG. 6 illustrates another exemplary embodiment of a supporter 50 according to be present invention.

As illustrated in FIG. 6, the oxygen respirator 100 for emergency evacuations according to the present invention is used while being provided in the supporter 50 which may be furnished in a body of a person. The supporter 50 is formed in a vest type, a shoulder strap type, a belt type (buckle type), or a handbag type to use the supporter 50 having a suitable shape according to convenience of the user.

In FIG. 1, a pocket is provided in the supporter 50 and the mask module 50, the oxygen tank 40, and the communication means 13 are configured to be kept in the pocket.

Alternatively, the supporter 50 of the present invention may be formed to include an oxygen tank 40 pocket and a module pocket 51 as illustrated in FIG. 6.

The oxygen tank pocket 54 is configured to be shorter than the oxygen tank 40 and provided on one side of the supporter 50 and a Velcro is attached to a part of the bottom of the oxygen tank pocket 54 to easily fix and separate the oxygen container. When the plurality of oxygen tanks 40 is provided, the oxygen tanks 40 are formed in a form such as a backpack, or the like, and as a result, the user conveniently carries the oxygen tanks 40.

The module pocket 51 is formed in a semi spherical shape and provided on the other side of the supporter 50 and the center of the module pocket 51 is separated, and as a result, the module pocket 51 may include the mask module 50. Further, the module pocket 51 is coupled with the supporter 50 in a form which is easily detachable/attachable, such as the Velcro, or the like. The module pocket 51 is made of an elastic material to easily store and keep the mask module 50 without a locking device such as a zipper, or the like. Further, since the locking device, the zipperor the like is not present, the mask module 50 may be rapidly taken out and worn under the emergency situation.

Meanwhile, the oxygen respirator 100 for emergency evacuations according to the present invention has various convenient functions.

The oxygen respirator 100 for emergency evacuations according to the present invention may attach with a lighting device or a Mutinous body which may brighten the darkness, and a tool for the convenience of the worker to the holder 50.

When the emergency situation occurs in the working site, the oxygen respirator 100 for emergency evacuations according to the present invention is formed to include the communication means 13 which may perform bidirectional communication with the control center in order to facilitate the evacuation of the user and against a case in which the user does not yet evacuate and the user is locked in the enclosed space or the user suffers from the accident and the user cannot move.

When the communication means 13 recognizes a distance and a motion between the users, the communication means 13 recognizes a situation in which a slave registered in a master goes beyond a designated distance or has no motion and transfers the danger of the user to the control center to enable rapid rescue.

When the communication means 13 recognizes the location and the motion of the user, the location may be determined, and as a result, the control center may help the user does beyond the disaster site by controlling movement of the user.

The communication means 13 may use a pairing technology as a technology that can recognize the distance between the users. The pairing technology transmits and receives Personal Identification Number (PIN) codes of terminals to and from each other to authenticate the terminals or may set pairing with a wireless communication device corresponding to a beacon having a largest link quality index (LQI) among received beacons. In the case of the distance between the users, when a received strength is measured and a signal at a predetermined level or less is sensed, it may be determined that the users go beyond a predetermined distance.

A technology that forms short-range wireless networking may be constituted by ISM-band WLAN, Bluetooth, ZigBee, and the like. A wireless mesh network (WMN) is a set of nodes autonomously configured by one multi-hop network. A mesh bridge as a node that simultaneously participates in one or more mesh networks at once is a node which immediately accesses at least two mesh networks. The bridge is similar to a repeater or a network hub which is a device connecting network segments in a physical layer, but not just retransmission but it is determined whether the bridge does not just retransmit a data packet, but may analyze and transmit the data packet and manages traffic. When the bridge is used, various interfaces are easily managed and an IP address is assigned only to a bridge interface unlike an ad-hoc mode in which the IP address needs to be assigned to each interface. In the present invention, the ad-hoc mode may be used and a multi-channel multi-interface based wireless distribution (WDS) operating mode may be used and a WDS bridge mesh routing (WBMR) protocol in which communication through a static link of nodes is enabled by using the bridge may be adopted.

As a representative system that may acquire positional information of the user, a global positioning system (GPS) and a position measuring system using a mobile communication network may be provided, In particular, the GPS is widely used due to an advantage in which more precise position measurement is available and the GPS is usable at all places on the earth as compared with the position measuring system using the mobile communication network. However, the GPS has an disadvantage in that it is difficult to use the GPS indoors due to a characteristic of the GPS requiting line of sight (LoS) and precise position measurement requiring an error range of tens of cm or less is difficult. Further, in a ubiquitous computing environment in which an embedded computer is used while being inherent in a surrounding environment and an object, a price of a device is a very important factor, and as a result, it may be determined that the GPS which is comparatively expensive is not suitable.

Meanwhile, in a specific region having a limited range, such as a room, a storage tank, or an underground, relative positional information indicating a distance of a location from a reference location will be more useful than absolute positional information expressed by a latitude and a longitude. From the above viewpoint, the need for a new position measuring system which may substitute for the GPS wisely used outdoors comes to the fore, and as a result, a low-priced position measuring system that is mounted on a device of the user or a sensor node to determine a relative location is required. An exemplary embodiment of the position measuring method includes triangulation and scene analysis and proximity and a position measuring system for recognizing a location of the user or the user device in a room or a propagation shadow area where the OPS may not be used includes an active badge using infrared as and an active vat using ultrasonic waves and a cricket system. RADAR measuring a transfer delay or intensity of a propagation signal, a 3D-iD system using a stereoscopic image, a position measuring system using RF-ID or UWB, and the like. Besides, the position measuring method includes systems for measuring locations of sensor nodes in an ad-hoc based wireless sensor network.

The communication means 13 of the present invention warns the dangerous situation through sound, letters, or flickering lamp by recognizing that the user goes beyond a predetermined distance or more or the user does not move by using a motion sensor, a vibration sensor, or a gyro sensor and transmits the dangerous situation to the control center, and as a result, the user may be rescued. A lamp such as an LED, or the like which may brighten the darkness may be mounted on a hedron module to be used as a flickering lamp for a rescue signal, and the like.

As a method for using the oxygen respirator 100 for emergency evacuations according to the present invention, one of methods described below may be used or a plurality of methods may be combined and used.

1. In the oxygen respirator 100 for emergency evacuations according to the present invention, an exhaled breath is stored in the pouch 30 through the detour check valve (not illustrated) and the pouch connection portion 20b and thereafter, the stored exhaled breath is used for respiration by removing carbon dioxide and moisture through the filter 23.

2.In the oxygen respirator 100 for emergency evacuations according to the present invention, the filter 23 includes each of an exhaled breath filter and an inhaled breath filter and when the carbon dioxide is removed by using the exhaled breath filter and the moisture is removed by the inhaled breath filter, the exhaled breath is stored in the pouch 30 through the exhaled breath filter and the stored air is breathed through the inhaled breath filter. Alternatively, when a common filter is used for the exhaled breath and the inhaled breath, the air is breathed by simultaneously removing the carbon dioxide and the moisture through the same .filter during respiration

3. In the oxygen respirator 100 for emergency evacuations according to the present invention, the exhaled breath is stored in the pouch 30 through the pouch check valve 27 and air acquired by removing the carbon dioxide and the moisture included in the stored exhaled breath through the filter 23 is breathed.

All of clauses 1, 2, and 3 reusing the exhaled breath are mixed with the fresh oxygen supplied from the oxygen tank 40 in the pouch 30.

The present invention is not limited to the exemplary embodiments and an application range is diversified and various modifications of the present invention can be made without departing from the gist of the present invention in the claims.

### INDUSTRIAL APPLICABILITY

According to the present invention, an oxygen respirator for emergency evacuations immediately supplies fresh oxygen at a location where the user is positioned under an emergency situation, thereby reducing an inhalation amount of toxic gas of the user, allows the user to consistently and stably breathe oxygen for a sufficient time until the user is rescued, performs bidirectional communication with a control center by using a communication means provided in a face mask to rapidly rescue the user, and in particular, allows the user to be rapidly and easily rescued when the user is locked in an enclosed space or cannot move.

1. An oxygen respirator for emergency evacuations in which respective components are coupled to or separated from each other and a communication means enabling mutual communication between users or communication with a control center is provided, comprising:
a face mask in which the center of the face mask is formed to be convex and the face mask is thus in close contact with the face so as to cover a mouth and a nose of the user and the oxygen is contained in the face mask and a mask check valve is formed on one side of the face mask;
a filtering unit formed to include a pouch connection portion formed on one side thereof, a filter unit of which one side is in communication with the pouch connection portion and the other side is in communication with the face mask, and a filtering means formed in the filter unit;
a pouch check valve formed in the filtering unit;
a pouch storing an exhaled breath of the user and connected to the pouch connection portion at one side so as to reuse the stored exhaled breath by removing carbon dioxide and oxygen through the filter unit; and
an oxygen supply hose of which one side is in communication with the filtering unit and the other side is connected to an oxygen tank to supply oxygen,
wherein a mask module is formed to include the face mask, the filtering unit, the pouch, and the oxygen supply hose and the mask module and the oxygen tank are used while being provided in a supporter or a backpack.

2. The oxygen respirator of claim 1, wherein the oxygen respirator for emergency evacuations first stores the exhaled breath in a pouch through the pouch check valve and discharges the remaining exhaled breath to the outside through the mask check valve when the user respires.

3. The oxygen respirator of claim 1, wherein the filtering means includes a filter formed in a sheet shape in which carbon and zeolite are stacked; and
a filter protection member provided in an anteroposterior direction of the filter to protect and support the filter and formed in a mesh structure.

4. The oxygen respirator of claim 1, further comprising:
a band bracket between the filter unit and the pouch.

5. The oxygen respirator of claim 1, wherein the oxygen tank is constituted by one selected from an oxygen compression container having a high pressure of 1 to 500 atmospheric pressure and having a small capacity less than 300 cc, an oxygen generation container using an oxygen generation agent, and an oxygen storage container in which gaseous oxygen is absorbed and using an oxygen storage releasing the absorbed oxygen, and a combination of a plurality of containers and further includes a static pressure type depressurizer.

6. The oxygen respirator of claim 1, wherein the face mask is formed in a folding type or a bellows type or a combination of the folding type and the bellows type.

7. The oxygen respirator of claim 1, wherein the filtering unit is coupled with the face mask so that the filter unit is projected to the front of a convex portion of the face mask.

8. The oxygen respirator of claim 1, wherein the filtering unit is coupled with the face mask so that the filter unit is projected to the bottom of the convex portion of the face mask.

9. The oxygen respirator of claim 1, wherein the oxygen supply hose as a hose of a material which is resistant to pressure and is flexible is connected with the oxygen tank by one touch fitting.

10. The oxygen respirator of claim 1, wherein the plurality of oxygen tanks are connected in series or in parallel, and as a result, when one oxygen tank is consumed, another oxygen tank is able to be used.

11. The oxygen respirator of claim 1, wherein the supporter is constituted by any one of a vest type, a shoulder strap type, a belt type (buckle type), and a handbag type or a combination of a plurality of types.

12. The oxygen respirator of claim 1, wherein the mask module and the communication means are provided in a pocket or a backpack of the supporter and the pocket is formed to be detached from or coupled to the supporter.

13. The oxygen respirator of claim 1, wherein the communication means gives a warning by one selected from sound, letters, and flickering or a combination of a plurality of forms by sensing a distance between users and a motion of the user.

14. The oxygen respirator of claim 13, wherein the communication means uses paring of Bluetooth communication and ZigBee communication for sensing the distance between the users and the motion of the user.

15. The oxygen respirator of claim 1, wherein the communication means recognizes a location and a distance of the user by using active badge using infrared or ultrasonic waves or a radar scheme using a propagation signal to perform bidirectional communication with the control center.

16. The oxygen respirator of claim 1, wherein the communication means transmits a dangerous situation to the control center when there is no motion by using a motion sensor, a vibration sensor, or a gyro sensor.

17. The oxygen respirator of claim 1, further comprising:
a lighting device or a luminous body.

18. A method for using an oxygen respirator for emergency evacuations, which includes the oxygen respirator for emergency evacuations according to claim 1, wherein a detour check valve is formed on the face mask, an exhaled breath is stored in a pouch through the detour check valve and a pouch connection portion and thereafter, the stored exhaled breath is breathed by removing carbon dioxide and moisture through a filter or the filter includes each of an exhaled breath filter and an inhaled breath filter and when the carbon dioxide is removed by using the exhaled breath filter and the moisture is removed by the inhaled breath filter, the exhaled breath is stored in the pouch through the exhaled breath filter and the stored air is breathed through the inhaled breath filter or when a common filter is used for the exhaled breath and the inhaled breath, the air is breathed by simultaneously removing the carbon dioxide and the moisture through the same filter during respiration or the exhaled breath is stored in the pouch through the pouch check valve and air acquired by removing the carbon dioxide and the moisture included in the stored exhaled breath through the filter is breathed.
